(19) United States
(12) Patent Application Publication
(10) Pub. No.: US 2003/0200694 A1
(43) Pub. Date: Oct. 30, 2003

(54) Animal lure

(76) Inventor: Keith E. Burrison, Howell, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/132,497

(22) Filed: Apr. 25, 2002

(51) Int. Cl. A01M 1/00

(52) U.S. Cl. 43/1

(57) ABSTRACT

An animal lure having a flexible pouch which is at least partially filled with a flexible material having shape memory. Due to the shape memory of the flexible material within the pouch, upon deformation of the pouch and the corresponding deformation of the flexible material, the flexible material emits an audible noise simulating the sound of an animal walking on fallen leaves.

### BACKGROUND OF THE INVENTION

I. Field of the Invention

The present invention relates generally to sporting devices and, more particularly, to an animal lure.

II. Description of Relevant Art

Animal hunters, and particularly deer hunters, frequently use various devices in order to lure the prey toward the hunter. These previously known animal lures take on a number of different forms.

For example, many hunters utilize a scent lure, such as animal urine, to attract the prey toward the hunter. The disadvantage of these previously known scent lures, however, is that they are expensive to obtain and are depleted when used.

Still other kinds of animal lures generate an audible noise of one sort or another to attract the prey. These sounds are typically designed to simulate the mating calls or other mating activities for the prey. Such lures, however, are relatively expensive to manufacture and obtain and have exhibited only limited success in their use.

### SUMMARY OF THE PRESENT INVENTION

The present invention provides an animal lure which overcomes all of the above-mentioned disadvantages of the previously known devices.

In brief, the animal lure of the present invention comprises a flexible pouch which is preferably constructed of a synthetic material, such as a plastic mesh material. Such material, furthermore, is weather resistant and thus does not deteriorate when subjected to rain, snow or other weather elements.

A flexible material having shape memory is contained within and preferably fills the pouch. This flexible material preferably comprises one or more sheets of polypropylene which are compressed and inserted into the pouch.

In use, the hunter deforms the pouch by squeezing it with his or her hands. Such deformation of the pouch simultaneously deforms the flexible material contained within the interior of the pouch. This material, since it has shape memory, emits an audible crinkling noise which closely simulates the sound of an animal, such as a deer, walking on fallen leaves. In use, the prey hearing the noise exhibited by the repeated deformation of the pouch and its contained flexible material attracts the deer toward the hunter in the desired fashion.

### BRIEF DESCRIPTION OF THE DRAWING

A better understanding of the present invention will be had upon reference to the following detailed description, when read in conjunction with the accompanying drawing, wherein like reference characters refer to like parts throughout the several views, and in which:

FIG. 1 is a diagrammatic elevational view illustrating the use of the present invention;

FIG. 2 is a plan view illustrating the preferred embodiment of the present invention; and

FIG. 3 is a view taken substantially along line 3-3 in FIG. 2.

### DETAILED DESCRIPTION OF A PREFERRED EMBODIMENT OF THE PRESENT INVENTION

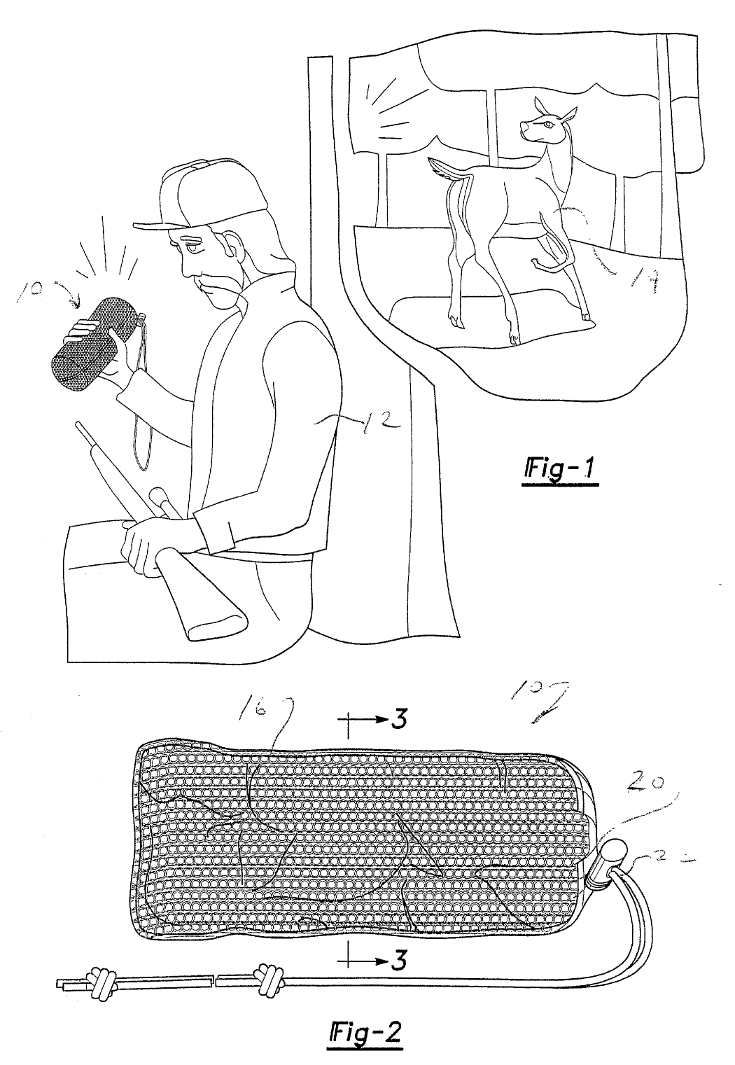

With reference first to FIG. 1, a preferred embodiment of the animal lure 10 of the present invention is shown for use by a hunter 12 to attract his animal prey 14, such as a deer. Furthermore, such animal prey 14 are hunted almost exclusively in the wild, such as forested areas.

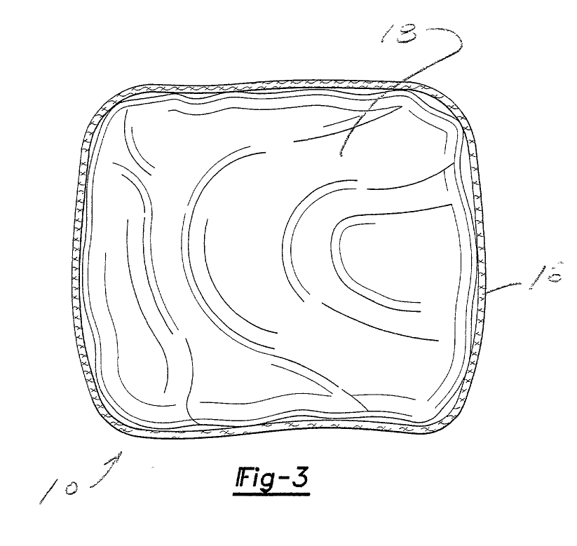

With reference now to FIGS. 2 and 3, the animal lure 10 is shown in greater detail and comprises an elongated pouch 16. The pouch 16, furthermore, is preferably made from a synthetic material, such as a plastic or nylon mesh material, which is weather resistant. As such, the pouch 16 does not degrade or deteriorate when subjected to rain, snow or other weather elements. Alternatively, the pouch is constructed of cloth.

Still referring to FIGS. 2 and 3, the interior of the pouch 16 is filled with a flexible material 18 (FIG. 3) which has shape memory. Preferably, the flexible material 18 is formed from one or more sheets of a polymeric material which is inserted through an open end 20 (FIG. 2) of the pouch 16. Preferably, the entire interior of the pouch 16 is filled with the flexible material 18 after which the open end 20 of the pouch 16 is closed by a cinch cord 22.

Since the flexible material 18 has shape memory, deformation of the flexible material 18 by deformation of the pouch 16 causes the flexible material 18 to emit an audible noise akin to a crinkling noise. Furthermore, this audible noise closely simulates the sound of an animal 14 walking on fallen leaves.

Preferably, the flexible material 18 is constructed of a polymeric material so that the flexible material 18, like the pouch 16, is weather resistant and does not deteriorate when exposed to rain, snow, and other weather elements. Other materials, of course, may be utilized without deviating from the spirit or scope of the invention.

With reference again to FIG. 1, in order to attract the prey 14 toward the hunter 12, the hunter repeatedly squeezes and releases the lure 10. In doing so, the lure 10 emits the audible noise simulating the sound of the prey walking on fallen leaves. The prey 14, believing that the sound from the lure 10 represents other animals of his type, is attracted to the noise from the lure 10 and thus attracted toward the hunter 12.

From the foregoing, it can be seen that the lure 10 of the present invention is not only simple and inexpensive to manufacture, but is also effective in use. Furthermore, all of the components of the lure 10 are constructed from weather resistant material so that the lure 10 does not degrade upon exposure to rain, snow and other weather elements. Furthermore, use of the lure 10 does not deplete the lure 10 such that the lure 10 may be used indefinitely.

Having described my invention, however, many modifications thereto will become apparent to those skilled in the art to which it pertains without deviation from the spirit of the invention as defined by the scope of the appended claims.

I claim:

1. An animal lure comprising:
a flexible pouch,
flexible material having shape memory contained within said pouch which, when deflected by deformation of said pouch, emits an audible noise.

2. The invention as defined in claim 1 wherein the audible noise simulates the sound of an animal walking on fallen leaves.

3. The invention as defined in claim 1 wherein said flexible material comprises at least one sheet of a polymeric material.

4. The invention as defined in claim 3 wherein said polymeric material comprises polypropylene.

5. The invention as defined in claim 1 wherein said pouch is constructed of a plastic material.

6. The invention as defined in claim 1 wherein said pouch is constructed of a plastic mesh material.

7. The invention as defined in claim 1 wherein said pouch includes an opening and comprising a cinch cord for selectively closing said opening.

8. The invention as defined in claim 1 wherein said pouch is constructed of cloth.
